(19) United States
(12) Patent Application Publication
(10) Pub. No.: US 2005/0086401 A1
(43) Pub. Date: Apr. 21, 2005

(54) Method, apparatus, system, and article of manufacture for generating interrupts

(75) Inventor: Patrick L. Connor, Portland, OR (US)

Correspondence Address: KONRAD RAYNES VICTOR & MANN LLP, Suite 210, 315 S. Beverly Drive, Beverly Hills, CA, 90212, US

(73) Assignee: Intel Corporation

(21) Appl. No.: 10/687,944

(22) Filed: Oct. 17, 2003

(51) Int. Cl. G06F 13/14

(52) U.S. Cl. 710/48

(57) ABSTRACT

Provided are a method, apparatus, system, and article of manufacture, wherein in one embodiment of the method a plurality of timers may be configured with interrupt event arrival rates. A rate of arrival of one or more interrupt events may be measured. An interrupt may be asserted in response to the measured rate of arrival of the one or more interrupt events being lower than the interrupt event arrival rates.

### BACKGROUND

1. Field

The disclosure relates to a method, apparatus, system, and article of manufacture for generating interrupts.

2. Background

A network interface, such as, an Input/Output (I/O) controller may be capable of receiving tens or hundreds of thousands of packets per second, where the packets may be frames, cells, etc. Many I/O controllers use interrupts as a method of indicating the received packets to a device driver, to an associated protocol stack, and to applications that need the data included in the received packets.

Frequent interrupts may reduce the performance of a computational system that includes the I/O controller. A high rate of interrupt can increase the utilization of the central processing unit (CPU) of the computational unit. As a result, the system may become CPU limited and may become unable to service the received packets. Furthermore, the amount of processing time available to other parts of the protocol stack, operating system, applications, etc., may be reduced. There may be delays in sending acknowledgments or subsequent packets may be dropped. The overall system throughput and reliability of the system may be reduced and livelock may occur. Livelock refers to a state where the processor bandwidth is largely consumed by interrupt processing and other functions are starved.

Certain I/O controllers may implement interrupt moderation techniques to reduce the frequency of interrupts. In certain implementations, the number of interrupts may be reduced by allowing a single interrupt to indicate the occurrence of several interrupt events. For example, a single interrupt may be generated for every ten packets that are received.

### BRIEF DESCRIPTION OF THE DRAWINGS

Referring now to the drawings in which like reference numbers represent corresponding parts throughout:

FIG. 1 illustrates a block diagram of a computing environment, in accordance with certain described embodiments;

FIG. 2 illustrates a block diagram of data structures, in accordance with certain described embodiments;

FIG. 3 illustrates operations for moderating interrupts, in accordance with certain described embodiments;

FIG. 4 illustrate the expiration of timers, in accordance with certain described embodiments; and

FIG. 5 illustrates a block diagram of a computer architecture in which certain described embodiments are implemented.

### DETAILED DESCRIPTION

In the following description, reference is made to the accompanying drawings which form a part hereof and which illustrate several embodiments. It is understood that other embodiments may be utilized and structural and operational changes may be made without departing from the scope of the present embodiments.

A high level of interrupts in a system may degrade system performance. The embodiments comprise an interrupt generator that may moderate interrupts at various packet arrival rates by using a plurality of timers with various reset criteria. The interrupt generator may assert interrupts when one of the reset criteria is not met within an allotted time.

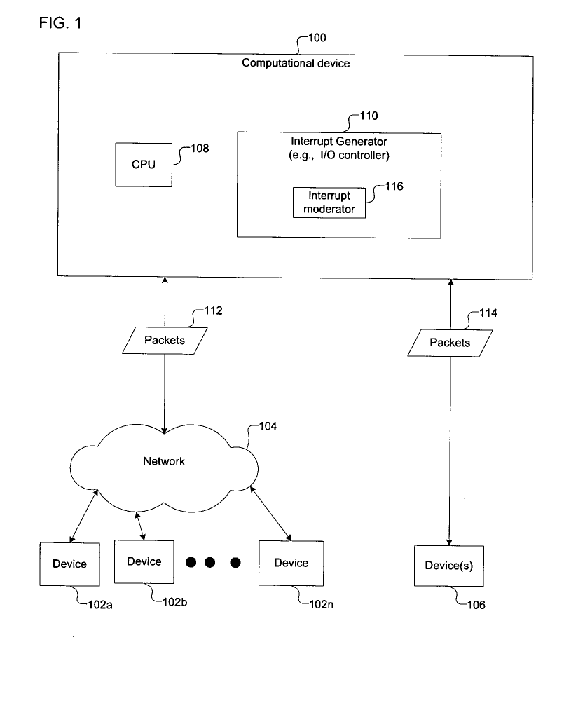

FIG. 1 illustrates a block diagram of a computing environment, in accordance with certain described embodiments. A computational device 100 is coupled to one or more devices, such as, devices 102a . . . 102n over a network 104. The computational device 100 may also be coupled to one or more devices, such as, device 106, without a network, such as, through direct lines, common bus systems, etc.

The computational device 100 and the devices 102a . . . 102n, 106 may include personal computers, workstations, servers, mainframe computers, hand held computers, palm top computers, telephony devices, network appliances, etc. The devices 102a . . . 102n, 104 may also include printers, storage devices, and other hardware and software devices that may communicate with the computational device 100.

The network 104 may be a network, such as, the Internet, an intranet, a Local area network (LAN), a Storage area network (SAN), a Wide area network (WAN), a wireless network, etc. In certain embodiments, the network 104 is a high speed network. Also the network 104 may be part of one or more larger networks or may be an independent network or may be comprised of multiple interconnected networks. The devices 102a . . . 102n and the computational device 100 may communicate via a client-server paradigm, a peer-to-peer paradigm, or other network paradigm.

The computational device 100 has at least one central processing unit (CPU) 108 and at least one interrupt generator 110. The interrupt generator 110 may be a device capable of generating an interrupt. For example, the interrupt generator 110 includes timers, codec and cryptographic devices, and I/O devices such as keyboards, mice, disk controllers, serial and parallel ports to printers, scanners, network controllers, modems, and display devices.

In certain embodiments, the interrupt generator 110 is an I/O controller connected to a bus on the computational device 100. The interrupt generator 110 receives and transmits packets 112, 114 between the computational device 100 and the devices 102a . . . 102n, 106. The interrupt generator 110 may be implemented in hardware circuitry, software or firmware. In certain embodiments, the interrupt generator 110 may be integrated directly into the computational device 100 by circuitry or instructions disposed on a motherboard of the computational device 100. Alternatively, the interrupt generator 110 may comprise a separately attached peripheral card, such as a network interface card (NIC). For example, the interrupt generator 110 may comprise a Personal Computer Memory Card International Association (PCMCIA) compatible peripheral card. In certain embodiments, the interrupt generator 110 may communicate with network 104 via copper cabling, such as Category 5 twisted pair, fiber optic, wireless, such as IEEE 802.11, infrared or other media.

The interrupt generator 110 provides an interface between the computational device 110 and the devices 102a . . . 102n, 106. For example, the interrupt generator 110 may receive one or more packets of data from the network 104 and indicate receipt of the one or more packets by asserting an interrupt to a device driver (not shown) in the computational device 100. The interrupt generator 110 may also send packets 112, 114 from the computation device 100 to the devices 102a . . . 102n, 104 via the network 104 or via direct connections.

An interrupt moderator 116 that implements certain embodiments is coupled to the computational device 100. In one embodiment, the interrupt moderator 116 is coupled to the interrupt generator 110. The interrupt moderator 116 may be implemented in software, hardware circuitry or firmware. If implemented in software, the interrupt moderator 116 may be written in a programming language and may be part of other applications. In certain alternative embodiments, the interrupt moderator 116 may be coupled to a device driver or may reside outside the interrupt generator 110.

In many situations, such as, where the network 104 is a high speed network, the computational device 100 may receive a large number of packets 112, 114 per second. Based on the rate of arrival of packets the interrupt generator 110 may be capable of generating a large number of interrupts that may increase the processing load on the CPU 108. The interrupt moderator 116 coupled to the interrupt generator 110 may moderate the number of interrupts generated by the interrupt generator 110.

In the system illustrated in FIG. 1, the interrupt moderator 116 coupled to the interrupt generator 110 moderates the number of interrupts generated by the interrupt generator 110.

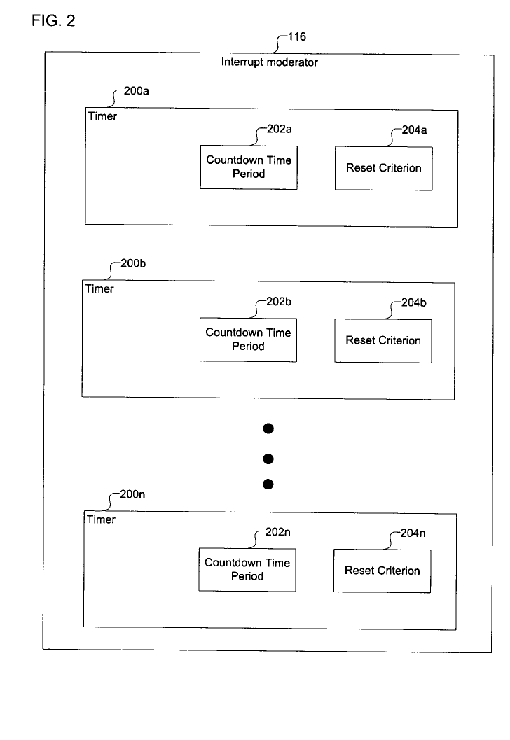

FIG. 2 illustrates a block diagram of data structures coupled to the interrupt moderator 116, in accordance with certain embodiments. In certain embodiments the data structures illustrated in FIG. 2 are implemented in the hardware circuitry of the interrupt generator 110 that includes the interrupt moderator 116. In alternative embodiments, the data structures may be implemented in software or firmware.

The interrupt moderator 116 includes a plurality of timers 200a . . . 200n, where a timer has a countdown time period and a reset criterion. For example, timer 200a has a countdown time period 202a and a reset criterion 204a, timer 200b has a countdown time period 202b and a reset criterion 204b, and timer 200n has a countdown time period 202n and a reset criterion 204n.

The timers 200a . . . 200n represent measuring devices. The countdown time period of a timer is the amount of time after which a timer expires. Different timers 200a . . . 200n may have different countdown time periods 202a . . . 202n. For example, if the countdown time period of timer 200a is 36.9 microseconds then in response to the timer 200a being reset, the timer starts counting down from 36.9 microseconds. If the timer 200a is not reset during the period of 36.9 microseconds then the timer 200a expires and an interrupt is asserted by the timer 200a. In response to an interrupt being asserted by a timer, the other timers may be reset. In the above example, if the timer 200a is not reset during the period of 36.9 microseconds then the timer 200a expires and timers 200b . . . 200n are reset.

The reset criterion of a timer represents a criterion such that if the criterion is met then the timer is reset and starts counting down from the countdown time period once again. For example, timer 200a may have a reset criterion that timer 200a would be reset after every three packets received by the computational device 100. If timer 200a has a countdown time period 202a of 36.9 microseconds, then if the three packets are received at the computational device 100 before the expiry of 36.9 microseconds the timer 200a is reset in response to the receipt of the third packet. No interrupt is asserted because the timer did not expire.

FIG. 2 illustrates that a timer is a measuring device that is configured with a rate of arrival of packets. If the arrival of packets stay below the configured rate of arrival then the timer expires and an interrupt is asserted. The plurality of timers may measure different rates of arrival of packets.

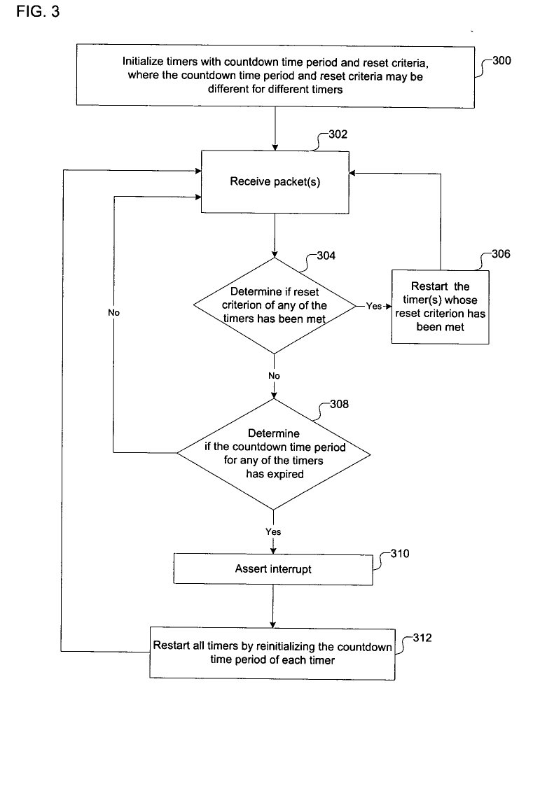

FIG. 3 illustrates how the interrupt moderator 116 moderates interrupts, in accordance with certain described embodiments.

Control starts at block 300, where the interrupt moderator 116 initializes the timers 200a . . . 200n with countdown time periods 202a . . . 202n and reset criteria. 204a . . . 204n. The countdown time periods 202a . . . 202n, as well as the reset criteria 204a . . . 204n may be different for different timers.

The interrupt moderator 116 receives (at block 302) packets 112, 114 that arrive at the interrupt generator 110 of the computational device 100. In certain embodiments, the packets may arrive at the computational device 100 from the devices 102a . . . 102n, 106. In alternative embodiments, interrupt events that are different from packets 112, 114 may arrive at the interrupt generator 110 of the computational device 100.

The interrupt moderator 116 determines (at block 304) if the reset criterion 204a . . . 204n of any of the timers 200a . . . 200n has been met, i.e., the condition of the reset criterion has been satisfied. If so, the interrupt moderator 116 restarts (at block 306) the one or more timers whose reset criterion has been met and the interrupt moderator continues (at block 302) to receive further packets. In an illustrative example, the reset criterion for a timer could indicate that the timer would be reset if three packets did not arrive within the countdown time period of the timer.

If the interrupt moderator 116 determines that the reset criterion 204a . . . 204n of any of the timers 200a . . . 200n has not been met, then the interrupt moderator 116 determines (at block 308) if the countdown time period 202a . . . 202n for any of the timers 200a . . . 200n has expired. If so, the interrupt moderator asserts (at block 310) an interrupt. The interrupt moderator 116 restarts (at block 312) the plurality of timers 200a . . . 200n by reinitializing the countdown time period 202a . . . 202n of the plurality of timers 200a . . . 200n and then continues (at block 302) to receive further packets.

If the interrupt moderator 116 determines that the countdown time period 202a . . . 202n for none of the timers 200a . . . 200n has expired, then the interrupt moderator 116 continues (at block 302) to receive further packets.

FIG. 3 illustrates that depending on the countdown period 202a . . . 202n and reset criterion 204a . . . 204n of a timer 200a . . . 200n, different timers may measure different rates of arrival of packets. If the arrival of packets stay below the rate of arrival measured by the timer then the timer expires and an interrupt is asserted. Certain embodiments group a number of interrupt events, such as, packet arrivals, and assert the corresponding interrupt. If the demand on system resources increases, such as, during times of high throughput, the number of interrupt events that are batched together may have to be increased so that the system can operate more efficiently. Latency may be the wait time for interrupt events to generate a corresponding interrupt. The embodiments balance the latency of interrupt events with the throughput of the system.

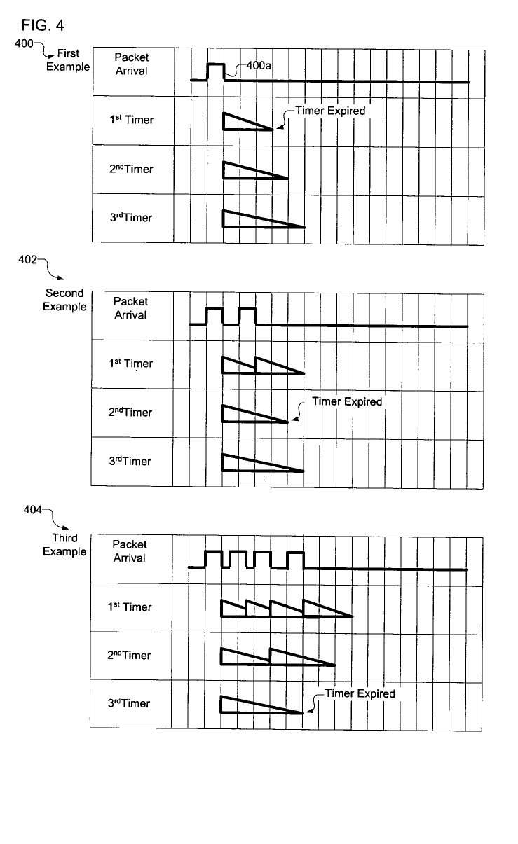

FIG. 4 illustrates exemplary expiration of timers and the assertion of interrupts, in accordance with certain described embodiments.

In FIG. 4, if the interrupt moderator 116 receives a packet, rather than immediately asserting an interrupt, the interrupt moderator 116 starts a first timer, a second timer, and a third timer. The first timer is three packet times in duration, i.e., the countdown time of the first timer is of the duration of three packet times. For example, the packet time in the case of a high speed network protocol may be 12.3 microseconds, and the countdown time of the first timer is then three times 12.3 microseconds, i.e., 36.9 microseconds. The first timer has a reset criterion, such that, the first timer restarts in response to one packet being received. Therefore, the first timer requires that a packet is to be received within three packet times of the last received packet or an interrupt would be asserted. Throughput loads above one third of wire-speed can satisfy the reset criterion of the first timer 402a.

The second timer requires that two packets be received within four packet times in order to satisfy the reset criterion of the second timer. Therefore, the second timer requires throughput loads greater than half of wire-speed to satisfy.

The third timer requires that four packets be received within five packet times in order to satisfy the reset criterion of the third timer. Therefore, the third timer requires throughput loads of at least four fifth wire-speed. Having a plurality of timers with various latency allowances and reset criteria allows interrupt moderation to scale with the throughout of the packets, without injecting large latencies at low throughput loads or allowing a large possible interrupt load at high throughput loads.

In a first example 400, the first timer expires because a subsequent packet does not arrive within three packet times of the trigger event, where the trigger event is the receipt of the first packet. When any of the timers expire, all other countdowns are canceled. The first example 400 is a low bandwidth example and has the lowest latency of all the examples shown in FIG. 4.

The second example 402 is a medium throughput example. A second packet arrives at a rate sufficient to cause the first timer to restart. However the reset criterion of the second timer was not met and the second timer expire. In the second example 402 the second timer expired before the second occurrence of the first timer and before the third timer. Tuning the timer countdown periods and the reset criterion relative to each other and the desired performance allows for embodiments that are either more latency sensitive or more interrupt moderating.

The third example 404 is a high throughput example. In the third example 404 the third timer expires. The rate of arrival of packets is sufficient to cause the first and second timers to reset and thus not expire. However, the stricter reset criterion of the third timer is not satisfied. In the third example 404, the reset criterion of the third timer is that four packets be received within five time periods but only three packets were received after the trigger event.

Therefore, in the embodiments a plurality of timers may be configured with interrupt event arrival rates. A rate of arrival of one or more interrupt events may be measured. An interrupt may be asserted if the measured rate of arrival of the one or more interrupt events is lower than the interrupt event arrival rates.

In the embodiments, having a plurality of timers that are optimized for various throughput values allows the interrupt rate to adjust dynamically with changes in the arrival rate of packets. The dynamic adaptation of the timers is immediate and interrupt moderation is not based only on the recent arrival rate of packets.

The countdown time period and the reset criterion of the plurality of timers can be chosen to meet different application requirements. In addition to the countdown time period and the reset criterion, the number of timers used in the interrupt used in the interrupt generator can also be changed depending on how fine the adaptability to throughput changes needs to be. The embodiments can balance latency and throughput in the generation of interrupts.

The described techniques may be implemented as a method, apparatus or article of manufacture involving software, firmware, micro-code, hardware and/or a combination thereof. The term “article of manufacture” as used herein refers to code, program instructions and/or logic implemented in circuitry (e.g., an integrated circuit chip, Programmable Gate Array (PGA), Application Specific Integrated Circuit (ASIC), etc.), and/or a computer readable medium (e.g., magnetic storage medium, such as hard disk drives, floppy disks, tape), optical storage (e.g., CD-ROMs, DVD-ROM, optical disk, etc.), volatile and non-volatile memory device (e.g., EEPROM, ROM, PROM, RAM, DRAM, SRAM, flash, firmware, programmable logic, etc.). Code in the computer readable medium is accessed and executed by a processor. The code in which the embodiments are implemented may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Of course, those skilled in the art will recognize that many modifications may be made to this configuration without departing from the scope of the embodiments, and that the article of manufacture may comprise an information bearing medium known in the art.

Certain embodiments may be used to improve performance by moderating the interrupt rate. Performance can be measured in many ways such as throughput (bits per second, transactions completed per unit of time, etc.) or operations per second. There are several benchmarks for measuring performance, such as, Spicant, SpecFP, Dhrystone, Khornerstone, Nhfsstone, ttcp, IOBENCH, IOZONE, Byte, Netperf, Nettest, CPU2, Hartstone, EuroBen, PC Bench/WinBench/NetBench, Sim, Fhourstones, Heapsort, Hanoi, Flops, C LINPACK, TFFTDP, Matrix Multiply (MM), Digital Review, Nullstone, Rendermark, Bench++, etc. For example, the Transaction Processing Performance Council TPC-C online transaction processing benchmark reports the throughput of specific mix of transactions, with the requirement that transactions must be completed within fixed time limits, as “tpmC”. A second metric “price/tpmC” reports the total cost of the system per transaction. SPEC publishes several benchmarks. SPEC stands for “Standard Performance Evaluation Corporation”, a non-profit organization with the goal to establish, maintain and endorse a standardized set of relevant benchmarks that can be applied to the newest generation of high-performance computers.

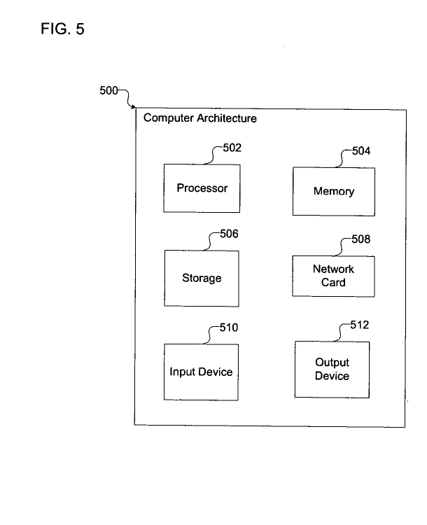

FIG. 5 illustrates a block diagram of a computer architecture in which certain aspects of the embodiments are implemented. FIG. 5 illustrates one embodiment of the computational device 100. The computational device 100 may implement a computer architecture 500 having a processor 502 (such as the CPU 108), a memory 504 (e.g., a volatile memory device), and storage 506. The storage 506 may include one or more non-volatile memory devices (e.g., EEPROM, ROM, PROM, RAM, DRAM, SRAM, flash, firmware, programmable logic, etc.), magnetic disk drives, optical disk drives, tape drives, etc. The storage 506 may comprise an internal storage device, an attached storage device or a network accessible storage device. Programs in the storage 506 may be loaded into the memory 504 and executed by the processor 502. The architecture may further include a network card 508 to enable communication with a network, such as, network 104. The architecture may also include at least one input device 510, such as a keyboard, a touchscreen, a pen, voice-activated input, etc., and at least one output device 512, such as a display device, a speaker, a printer, etc.

In certain implementations, interrupt generator may be included in a computer system including any storage controller, such as a Small Computer System Interface (SCSI), AT Attachment Interface (ATA), Redundant Array of Independent Disk (RAID), etc., controller, that manages access to a non-volatile storage device, such as a magnetic disk drive, tape media, optical disk, etc. In alternative implementations, the embodiments may be included in a system that does not include a storage controller, such as certain hubs and switches. Further details of SCSI are described in the publication entitled “Information Technology: SCSI-3 Architecture Model,” prepared by the X3T10 Technical Committee (published November 1995). Further details of ATA are described in the publication entitled “AT Attachment-3 Interface (ATA-3)” prepared by the X3T10 Technical Committee (published October 1995).

In certain implementations, the embodiments may be implemented in a computer system including a video controller to render information to display on a monitor coupled to the computer system including the network generator, such as a computer system comprising a desktop, workstation, server, mainframe, laptop, handheld computer, etc. An operating system may be capable of execution by the computer system, and the video controller may render graphics output via interactions with the operating system. Alternatively, the embodiments may be implemented in a computer system that does not include a video controller, such as a switch, router, etc. Furthermore, in certain embodiments the network adapter may be included in a card coupled to a computer

The logic of FIG. 3 describes specific operations occurring in a particular order. Further, the operations may be performed in parallel as well as sequentially. In alternative embodiments, certain of the logic operations may be performed in a different order, modified or removed and still implement the alternative embodiments. Morever, steps may be added to the above described logic and still conform to the embodiments. Yet further steps may be performed by a single process or distributed processes.

Furthermore, many of the software and hardware components have been described in separate modules for purposes of illustration. Such components may be integrated into fewer number of components or divided into larger number of components. Additionally, certain operations described as performed by a specific component may be performed by other components.

The data structures and components shown or referred to in FIGS. 1-5 are described as having specific types of information. In alternative embodiments, the data structures and components may be structured differently and have fewer, more or different fields or different functions than those shown or referred to in the figures.

Therefore, the foregoing description of the embodiments has been presented for the purposes of illustration and description. It is not intended to be exhaustive or to limit the embodiments to the precise form disclosed. Many modifications and variations are possible in light of the above teaching.

1. A method, comprising:
configuring a plurality of timers with interrupt event arrival rates;
measuring a rate of arrival of one or more interrupt events; and
asserting an interrupt, in response to the measured rate of arrival of the one or more interrupt events being lower than the interrupt event arrival rates configured in the plurality of timers.

2. The method of claim 1, wherein the one or more interrupt events are arrivals of packets, and wherein the interrupt event arrival rates are different for at least two timers, and the measuring is performed with the at least two timers.

3. The method of claim 1, further comprising:
in response to asserting the interrupt, restarting the plurality of timers.

4. The method of claim 1, wherein the configuration further comprises:
initializing the plurality of timers with countdown time periods, wherein a countdown time period measures a period of time; and
initializing the plurality of timers with a reset criteria, wherein a first reset criterion for a first timer indicates a first number of interrupt events that are to be received by the first timer within a first countdown time period for the first timer to be restarted.

5. The method of claim 1, wherein the configuration of the plurality of timers regulates a latency of an arriving interrupt event in generating interrupts.

6. The method of claim 1, wherein the configuration, measurement, and assertion result in one interrupt being generated for a plurality of arriving events.

7. The method of claim 1, wherein the configuration, measurement, and assertion are performed by an interrupt generator, including an Input/Output controller, wherein the interrupt generator is coupled to a computational device, wherein the computational device is capable of receiving the one or more interrupt events to result in interrupts at one rate at which the computational device can process the interrupts without decreasing performance of other functions of the computational device.

8. The method of claim 1, wherein the configuration and assertion are performed by an interrupt moderator included in a computational device, wherein the interrupt moderator includes the plurality of timers, wherein an interrupt moderation level of a first timer is different from an interrupt moderation level of a second timer.

9. The method of claim 1, wherein the configuration of the plurality of timers is based on a consideration of possible load on a processor based on a level of possible interrupts to the processor and a desired latency of the arriving interrupt events.

10. An interrupt generator, wherein the interrupt generator is capable of being coupled to a computational device, the interrupt generator comprising:
a plurality of timers capable of being configured with interrupt event arrival rates; and
an interrupt moderator coupled to the plurality of timers, wherein the interrupt moderator is capable of measuring a rate of arrival of one or more interrupt events, and wherein the interrupt moderator is capable of asserting an interrupt in response to the measured rate of arrival of the one or more interrupt events being lower than the interrupt event arrival rates configured in the plurality of timers.

11. The interrupt generator of claim 10, wherein the interrupt generator is an I/O controller, wherein the one or more interrupt events are arrivals of packets, and wherein the interrupt event arrival rates are different for at least two timers.

12. The interrupt generator of claim 10, wherein in response an assertion of the interrupt, the interrupt moderator is capable of restarting the plurality of timers.

13. The interrupt generator of claim 10, wherein the interrupt moderator further comprises:
countdown time periods, wherein the interrupt moderator is capable of initializing the plurality of timers with the countdown time periods, wherein a countdown time period measures a period of time; and
reset criteria, wherein the interrupt moderator is capable of initializing the plurality of timers with the reset criteria, wherein a first reset criterion for a first timer indicates a first number of interrupt events that are to be received by the first timer within a first countdown time period for the first timer to be restarted.

14. The interrupt generator of claim 10, wherein a configuration of the plurality of timers is capable of regulating a latency of an arriving interrupt event in generating interrupts.

15. The interrupt generator of claim 10, wherein one interrupt is generated for a plurality of arriving interrupt events.

16. The interrupt generator of claim 10, wherein the interrupt generator is an Input/Output controller, wherein the computational device is capable of receiving the one or more interrupt events to result in interrupts at one rate at which the computational device is capable of processing the interrupts without a decrease in the performance of other functions of the computational device.

17. The interrupt generator of claim 10, wherein the interrupt moderator is included in the computational device, wherein the interrupt moderator includes the plurality of timers, wherein an interrupt moderation level of a first timer is different from an interrupt moderation level of a second timer.

18. The interrupt generator of claim 10, wherein the configuration of the plurality of timers is based on a consideration of possible load on a processor of the computational device based on a level of possible interrupts to the processor and a desired latency of the arriving interrupt events.

19. A system, comprising:
a computational device;
a data storage coupled to the computational device;
a data storage controller to manage Input/Output access to the data storage, wherein the data storage controller is coupled to the computational device;
an interrupt generator, wherein the interrupt generator is capable of being coupled to the computational device;
a plurality of timers capable of being configured with interrupt event arrival rates, wherein the plurality of timers is coupled to the interrupt generator; and
an interrupt moderator coupled to the plurality of timers, wherein the interrupt moderator is capable of measuring a rate of arrival of one or more interrupt events, and wherein the interrupt moderator is capable of asserting an interrupt in response to the measured rate of arrival of the one or more interrupt events being lower than the interrupt event arrival rates configured in the plurality of timers.

20. The system of claim 19, further comprising:
countdown time periods, wherein the interrupt moderator is capable of initializing the plurality of timers with the countdown time periods, wherein a countdown time period measures a period of time; and
reset criteria, wherein the interrupt moderator is capable of initializing the plurality of timers with the reset criteria, wherein a first reset criterion for a first timer indicates a first number of interrupt events that are to be received by the first timer within a first countdown time period for the first timer to be restarted.

21. The system of claim 19, wherein the interrupt generator is an Input/Output controller, wherein in response to the assertion of the interrupt, the interrupt moderator is capable of restarting the plurality of timers.

22. An article of manufacture, wherein the article of manufacture is capable of causing operations, the operations comprising:
configuring a plurality of timers with interrupt event arrival rates;
measuring a rate of arrival of one or more interrupt events; and
asserting an interrupt, in response to the measured rate of arrival of the one or more interrupt events being lower than the interrupt event arrival rates configured in the plurality of timers.

23. The article of manufacture of claim 22, wherein the one or more interrupt events are arrivals of packets, and wherein the interrupt event arrival rates are different for at least two timers, and the measuring is performed with the at least two timers.

24. The article of manufacture of claim 22, the operations further comprising:
in response to asserting the interrupt, restarting the plurality of timers.

25. The article of manufacture of claim 22, wherein the configuration further comprises:
initializing the plurality of timers with countdown time periods, wherein a countdown time period measures a period of time; and
initializing the plurality of timers with reset criteria, wherein a first reset criterion for a first timer indicates a first number of interrupt events that are to be received by the first timer within a first countdown time period for the first timer to be restarted.

26. The article of manufacture of claim 22, wherein the configuration of the plurality of timers regulates a latency of an arriving interrupt event in generating interrupts.

27. The article of manufacture of claim 22, wherein the configuration, measurement, and assertion result in one interrupt being generated for a plurality of arriving interrupt events.

28. The article of manufacture of claim 22, wherein the configuration, measurement, and assertion are performed by an interrupt generator, including an Input/Output controller, wherein the interrupt generator is coupled to a computational device, wherein the computational device is capable of receiving the one or more interrupt events to result in interrupts at one rate at which the computational device can process the interrupts without decreasing performance of other functions of the computational device.

29. The article of manufacture of claim 22, wherein the configuration and assertion are performed by an interrupt moderator included in a computational device, wherein the interrupt moderator includes the plurality of timers, wherein an interrupt moderation level of a first timer is different from an interrupt moderation level of a second timer.

30. The article of manufacture of claim 22, wherein the configuration of the plurality of timers is based on a consideration of possible load on a processor based on a level of possible interrupts to the processor and a desired latency of the arriving interrupt events.
